(19) United States
(12) Patent Application Publication
(10) Pub. No.: US 2003/0033604 A1
(43) Pub. Date: Feb. 13, 2003

(54) System using a computer as television set server

(76) Inventors: Jean-Yves Leroux, Ceyreste (FR); Laurent Jabiol, Ceyreste (FR)

Correspondence Address: GREENBLUM & BERNSTEIN, P.L.C., 1941 ROLAND CLARKE PLACE, RESTON, VA, 20191, US

(21) Appl. No.: 10/148,175

(22) PCT Filed: Oct. 4, 2001
(86) PCT No.: PCT/FR01/03058

(30) Foreign Application Priority Data
Oct. 4, 2000 (FR) 00/12641

(51) Int. Cl. H04N 7/18; G06F 15/16

(52) U.S. Cl. 725/82; 725/78; 709/219

(57) ABSTRACT

The invention concerns a system for using a computer as server for television sets. It consists of a module (4) connected to the decoder (1) of the television set (2) and to the computer (3) by digital links, and comprising a micro-electronic component (5) provided with enhanced filtering units and an interface for controlling the computer resources from a decoder by means of a specific software integrated therein. The invention concerns reception on a television set of data of all types, and in particular programs or data using coding by packets consisting of a set of data routed in blocks in a network, whether of the wireless type, by cable or satellite.

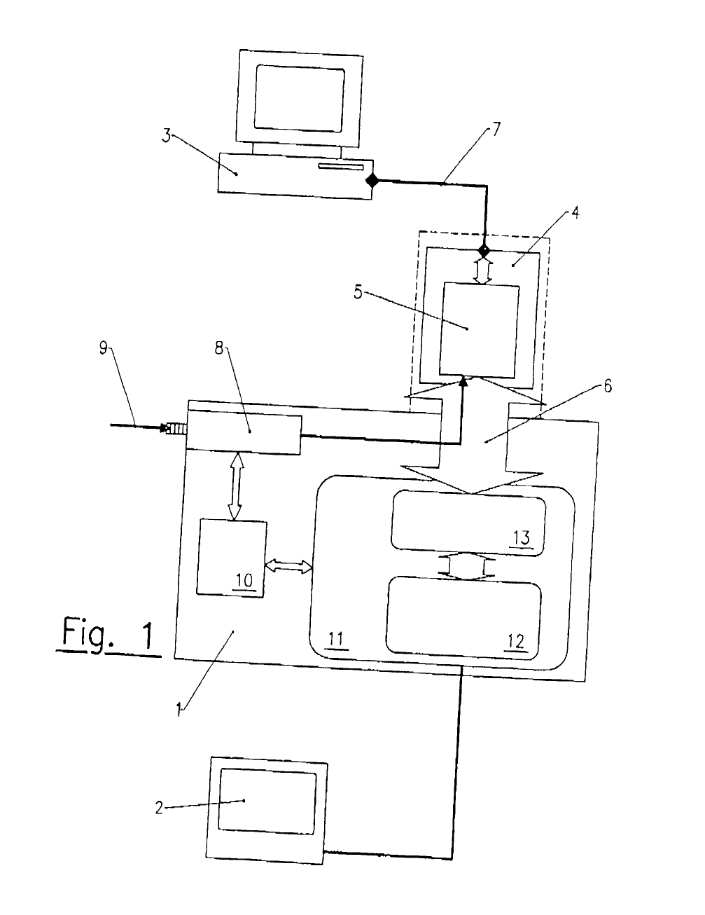

The present invention relates to a system allowing the use of a computer as a server for television sets.

Generally speaking, it relates to the field of reception of all types of data on a television set, particularly programs or data using coding by packets constituted of a set of data routed in blocks in a network, whether of the wireless type, by cable or satellite.

The reception of coded programs or digital services on a television set requires a decoder that generally is in the form of a box, allowing the interpretation and presentation of the data.

The current reception systems (digital decoders for digital flux by satellite, ground or cable) are limited in interactivity and functionality because they generally have few resources and particularly little or no memory. Computers, on the other hand, offer constantly improved possibilities: software for games, publishing, internet surfing, printing, etc.

New decoder systems with greater resources have begun to appear on the market; however, in spite of a cost equal to that of a computer, their resources are currently quite inferior to those of the latter.

In an office environment, it is possible to work with an office automation routed to a server without using a computer due to a terminal called a “thin client.” This pertains to a box provided with a minimum of components: a processor, a limited random access memory, possibly a low storage capacity and a network interface. This terminal lacks additional elements, such as a hard drive, multimedia equipment and floppy disk or CD-ROM drives, but it is equipped with ports for terminals of the parallel or USB type, that enable connecting a screen, a keyboard or a printer.

Due to its modest equipment, a thin client is less expensive than a conventional computer in terms of investment as well as maintenance.

A current digital decoder connected to a television set can be compared to a thin client, but until now there are no means to control a computer from a decoder.

The object of the device according to the invention is to overcome the current situation. It consists of using the resources of a computer for the current decoder/television set systems which are capable of receiving substantial quantities of data without being able to store them or use them for multiple applications.

The computer is regarded as a resource server, all home decoders/television sets are seen as an assembly of thin clients communicating with the server offering them its resources.

It is constituted of a module connected to the decoder by a digital link and comprising a micro-electronic component provided with enhanced filtering units and an interface for controlling the computer resources from the decoder by means of a specific software integrated therein.

The following description will be better understood with reference to the attached drawing, which is a schematic view of an installation according to the invention, and relates to a non-limiting example of one of the possible forms of embodiment. The representation in dotted lines indicates that the module can be external or integrated into the decoder.

This installation comprises a digital decoder 1 connected to a television set 2, a computer 3 and a module 4 which acts as an interface between the decoder and the computer.

The module 4, which comprises a micro-electronic component 5 that ensures the connecting functions, is connected to the digital decoder 1 preferably due to an interface 6 of the PCMIA type (a system used more particularly on laptops for adding memory or a modem) or, as an alternative, is integrated into the decoder. Furthermore, the module is connected to the computer 3 by an appropriate digital link 7 (1394, USB, DVB-CI module or PCMCIA with the output towards the computer, wireless connection).

The digital decoder 1 is provided with a tuner 8 connected to the network 9 that diffuses data, a micro-processor 10, as well as an electronic unit 11 comprising, in particular, the module 12 for managing the decoder and an integrated software 13 specific to the application.

The functioning of the system can be schematically described by the following scenario:

the decoder 1 is in the data reception mode, the data received is routed to the computer 3 by the digital link 7, the data is stored on the computer hard drive;

an application on the decoder 1/television set 3 assembly allows going from a conventional reception mode to a terminal emulation mode allowing access to the previously stored data, but also to a set of functions offered by the computer 3 (for instance, the computer modem and software allow writing, sending and checking e-mail from the television set 2, or a menu on the decoder 1 allowing to connect to internet sites or to load various games that were previously downloaded at high speed on the computer, etc.).

The more or less advanced remote control of the decoder 1 or of the television set 2

The more or less advanced remote control of the decoder 1 or of the television set 2 allows controlling access to these functions due to the specific software 13.

Two main functioning modes can be envisioned:

the decoder 1 has a special operating system capable of running software specific to this system: adapted applications are downloaded at high speed on the computer through the decoder. These applications are then available to the user of the decoder who can download them from the computer 3.

the computer allows the decoder to access all of its resources and can, upon request from the decoder, execute any application. Only the “image” of the execution is sent to the decoder. The remote commands from the user are entered into the decoder due to a remote control, then routed to the computer which interprets them as commands for the software that it executes for the decoder.

For this, a protocol is defined allowing:

on the one hand, to allow the decoder to interpret the images (or mirrors) sent by the server computer during execution of a task,

on the other hand, to interpret the user's commands and choices such that the user is under the impression that the task is being executed on the decoder 1.

### EXAMPLES OF APPLICATIONS

a) Multimedia Teletext

Periodically, all televised programs and their descriptions are sent at high speed and stored on the computer 3. Contrary to the conventional teletext, and even the new applications such as program guides (TPS, CanalSat, etc.), this “multimedia telenews” contains, in addition to text, images of programs to be broadcast, film previews, animations and possibly advertisements. The storage capacity of the computer can also allow storing several different “newspapers,” acting as a “kiosk” server. The user can then check his programs much better from his television set 2.

b) Digital Jukebox

Starting with an application of the decoder 1, the user can decide to download digital music (in the form of a set of files, or by routing to the computer 3 the audio channel of a television station). An application software integrated in the computer allows replaying the recorded songs and sending them to the decoder. This application can propose an enhanced interface due to the computer resources.

The positioning of the various components gives the object of the invention a maximum of useful effects that had not until now been obtained by similar devices.

1. System allowing the use of a computer as a server for television sets, adapted in particular to record and manipulate programs or data using coding by packets constituted of a set of data routed in blocks in a network, whether of the wireless type, by cable or satellite,
characterized by the combination of a module (4), integrated into or connected to the digital decoder (1) associated with the television set (2) and to the computer (3) by digital links (6, 7), and comprising a micro-electronic component (5) provided with enhanced filtering units and an interface for controlling the resources of said computer from said digital decoder due to a specific software (13) integrated therein.

2. System according to claim 1, characterized in that the module (4) is integrated into the digital decoder (1).

3. System according to claim 1, characterized in that the module (4) is connected to the digital decoder (1) due to an interface (6) of the PCMIA type.

4. System according to any of the preceding claims, characterized in that the module (4) is connected to the computer (3) by a high speed digital link (7) of the USB, 1394 type, or the like.

5. System according to any of claims 1-3, characterized in that the digital link (7) connecting the module (4) and the computer (3) is a wireless connection.

6. System according to any of the preceding claims, characterized in that the module (4) and the specific software (13) integrated into the digital decoder (1) are arranged so that the assembly formed of the digital decoder and the computer (3) have access to the functions offered by said computer.

7. System according to claim 6, characterized in that the module (4) and the specific software (13) are arranged so as to allow controlling access to the functions of the computer (3) by means of the remote control of the digital decoder (1) or of the television set (2).

8. System according to one of claims 6 and 7, characterized in that the module (4) and the specific software (13) are arranged so as to allow transmitting the data received by said decoder to the computer (3) by the digital link (7), and to store said data on the hard drive of said computer.

9. System according to claim 8, characterized in that the module (4) and the specific software (13) are arranged so as to be able to go from a conventional reception mode to a terminal emulation mode allowing access to data previously stored in the computer (3).

10. System according to any of the preceding claims, characterized in that the digital decoder (1) has a special operating system capable of running software specific to this system and of downloading adapted applications to the computer (3) at high speed via said decoder.

11. System according to any of the preceding claims, characterized in that the computer (3) is equipped to allow the digital decoder (1) to access all of its resources, and to execute any application upon its request with only the “image” of the execution being sent to said decoder.
